(19) United States
(12) Patent Application Publication
(10) Pub. No.: US 2024/0352924 A1
(43) Pub. Date: Oct. 24, 2024

(54) UNDERWATER GRAVITY ENERGY GENERATOR AND STORAGE SYSTEMS

(71) Applicant: Gheorghe Valentin AILENEI, Airdrie (CA)

(72) Inventor: Gheorghe Valentin AILENEI, Airdrie (CA)

(21) Appl. No.: 18/632,637

(22) Filed: Apr. 11, 2024

Related U.S. Application Data
(60) Provisional application No. 63/460,384, filed on Apr. 19, 2023.

(51) Int. Cl. F03G 3/00; F03B 13/00; H02K 7/10; H02K 7/116; H02K 7/18

(52) U.S. Cl. CPC F03G 3/094; F03B 13/00; H02K 7/1004; H02K 7/116; H02K 7/1853; H02K 7/1876

(57) ABSTRACT

Underwater energy generation and storage systems for use in a water body includes a floating platform for supporting a compressor assembly and surface electrical generators; a ballast platform for anchoring the floating platform and optionally supporting submerged electrical generators; a cylinder between the floating platform and the ballast platform; and an air/water tank moveable along the cylinder to generate electrical energy both in an upstroke towards the floating platform and a downstroke towards the ballast platform. The air/water tank may include a magnet assembly, with the cylinder including magnetic coil assemblies. The cylinder may be in the form of a rotatable cylindrical cam. Methods of using the systems are also provided.

### CROSS-REFERENCE TO RELATED APPLICATION

The present application claims the benefit of U.S. Provisional Application No. 63/460,384, filed Apr. 19, 2023.

### FIELD OF THE INVENTION

The present invention relates to systems and methods for generating and storing electrical energy. More specifically, the present invention relates to underwater systems and methods which use gravity for generating and storing electrical energy.

### BACKGROUND OF THE INVENTION

An uninterrupted supply of energy is one of the greatest challenges of the modern world. Existing energy storage can be generally grouped into broad technology categories including batteries, thermal, mechanical, pumped hydro, and hydrogen. Batteries include lithium-ion, sodium sulfur, lead acid, and flow batteries which vary in energy density, power performance, lifetime charging capacities, safety, and cost. Thermal storage captures heat in water, molten salts, or other working fluids, but is limited by the need for large underground storage caverns. Mechanical storage systems include flywheels and compressed air systems. Large-scale pumped hydro systems and compressed air energy storage are commonly used for their long discharge times and high capacity. In contrast, batteries and flywheels are positioned around lower power applications and shorter discharge times. Hydrogen from electrolysis can be stored and used in fuel cells, engines, or gas turbines to generate electricity without harmful emissions. Solar, wind, and tidal energy storage technologies are unpredictable, while coal energy and nuclear power emit pollution.

Attempts have been made to develop gravity-based energy storage systems. An energy vault system uses cranes and automated stacking and unstacking of blocks which are dropped to generate electricity. A gravitricity system suspends individual weights in their own shafts, with a winch that either lifts or releases the weight, such that the dropping weight generates electricity. Approaches using underwater pistons or combinations of weights and water are being developed.

While all the above energy storage technologies have their own pros and cons, each technology has tradeoffs in application, size, location, complexity, affordability, capacity, safety, and reliability. Accordingly, there remains a need for an improved energy storage technology which may overcome many of the shortcomings of these existing energy storage options.

### SUMMARY OF THE INVENTION

The present invention relates to underwater systems and methods which use gravity for generating and storing electrical energy.

In a first aspect, the invention comprises an underwater energy generation and storage system for use in a water body comprising:
a floating platform positioned on a surface of the water body for supporting a compressor assembly and one or more surface electrical generators;
a ballast platform positioned above or on a floor of the water body for anchoring the floating platform;
a cylinder coupled between the floating platform and the ballast platform; and
an air/water tank positioned concentrically with the cylinder and moveable along the cylinder to generate electrical energy in an upstroke towards the floating platform and a downstroke towards the ballast platform.

In some embodiments, the air/water tank comprises a magnet assembly, the magnet assembly comprising a plurality of magnets positioned circumferentially in a predetermined pattern within the body of the air/water tank. In some embodiments, the cylinder comprises one or more magnetic coil assemblies positioned spaced apart in a predetermined pattern along the cylinder.

In some embodiments, the system further comprises a gear box operably connected to the surface electrical generator. In some embodiments, the cylinder is configured in the form of a cylindrical cam comprising a plurality of guide channels. In some embodiments, the air/water tank is mounted onto guide poles extending between the floating platform and the ballast platform by a plurality of guide supports, the air/water tank comprising a follower capable of riding within the guide channels for rotating the cylinder.

In a second aspect, the invention comprises methods of generating and storing energy using the above systems comprising:
installing the system with the floating platform on a surface of a water body, and the ballast platform suspended above or resting on a floor of the water body;
generating, using the compressor assembly, sufficient compressed air to fill the surface air tanks and the submerged compressed air tanks;
opening the valves to allow the flow of water from the water body into the air/water tank;
closing the valves when the water reaches a predetermined level;
allowing the air/water tank to move under gravity towards the ballast platform in the downstroke to generate electrical energy;
opening the valves to allow the flow of water out of the air/water tank under pressure from the compressed air;
allowing the air/water tank to rise towards the floating platform in the upstroke to generate electrical energy; and
re-filling the submerged compressed air tanks with compressed air from the surface air tanks for a next cycle.

In some embodiments, the air/water tank pulls the upper cables connected to the surface electrical generators in the downstroke to generate electrical energy, and the air/water tank pulls the lower cables connected to the submerged electrical generators in the upstroke to generate electrical energy.

In some embodiments, the magnets of the air/water tank pass over the magnetic coil assemblies of the cylinder to generate electrical energy.

In some embodiments, the follower moves downwardly within the guide channels for rotating the cylinder and actuating gears for transferring energy to the surface electrical generator to generate electrical energy.

Additional aspects and advantages of the present invention will be apparent in view of the description, which follows. It should be understood, however, that the detailed description and the specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The invention will now be described by way of exemplary embodiments with reference to the accompanying drawings wherein:

FIG. 1 is a front perspective view of a first embodiment of the present invention.

FIG. 2 is a top view of the first embodiment of FIG. 1, showing the air/water tank and guide cylinder in phantom lines.

FIG. 3 is a front perspective view of a second embodiment of the present invention, showing a portion of the guide cylinder in phantom lines.

FIG. 4 is an enlarged view of a portion of the second embodiment of FIG. 3, showing a magnet assembly of the air/water tank and magnetic coil assemblies of the guide cylinder.

FIG. 5 is a front perspective view of a third embodiment of the present invention, showing a portion of the rotatable cylinder in phantom lines.

FIG. 6 is an enlarged view of a portion of the third embodiment of FIG. 5, showing the air/water tank and rotatable cylinder.

FIG. 7 is an enlarged view of a portion of FIG. 6, showing the rotatable cylinder.

FIG. 8 is a cross-sectional view of the rotatable cylinder of FIG. 7 taken along line 8-8, showing the inner and outer pipes and guide channels.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. The term “horizontal” means the orientation of a plane or line that is substantially parallel to the plane of the horizon. The term “vertical” means the orientation of a plane or line that is substantially at a right angle to the horizontal plane.

The present invention relates to underwater systems and methods which use gravity for generating and storing electrical energy. The invention may be suitable for use in any water body. As used herein, the term “water body” refers to any significant accumulation of surface water including, but not limited to, oceans, seas, lakes, rivers, and streams. As used herein, the “floor” of the water body refers to the bottom of the water body including, but not limited to, the ocean floor, ocean bottom, sea floor, seabed, riverbed, and the like.

The invention efficiently generates electrical energy using gravity on a downstroke and using a pressure differential (i.e., between underwater pressure and atmospheric air pressure) on an upstroke. Since electrical energy is generated during both the downstroke and upstroke, the need for any external energy supply is minimized. Further, the invention uses only a small amount of the stored energy in compressed air to maintain the generation cycle. The invention may be useful for various applications including, but not limited to, generating electrical energy for an electrical grid, powering loads at the point of demand, storing electrical energy, functioning solely to generate or store electrical energy (or both), and maintaining electrical energy over several cycles.

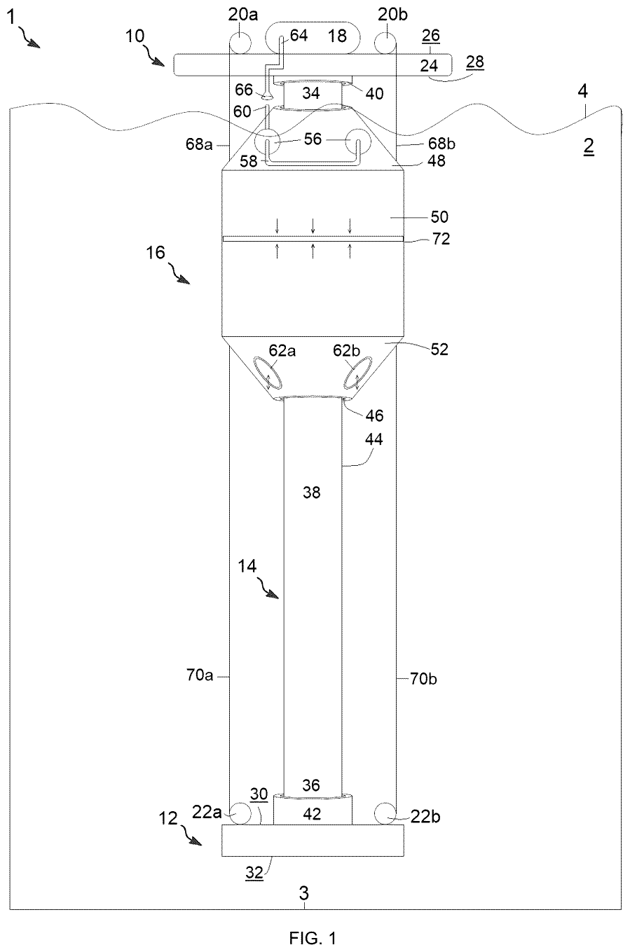

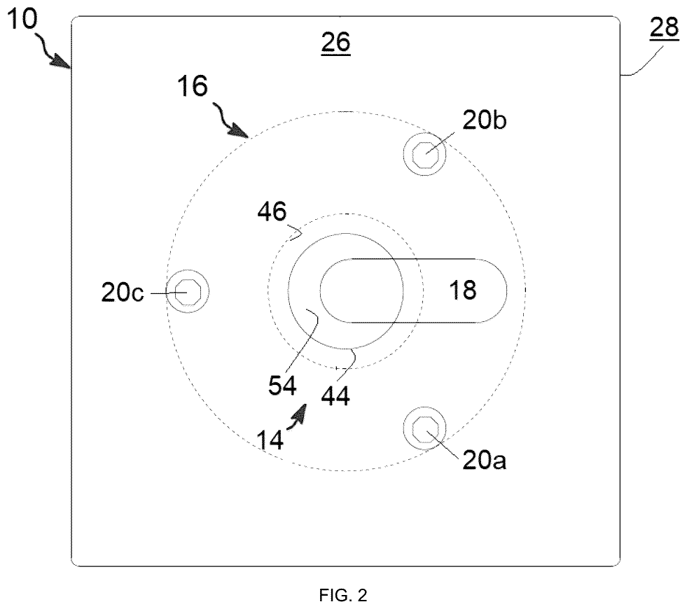

The invention will now be described having reference to the accompanying Figures. In a first embodiment, the underwater energy generation and storage system (1) for use in a water body (2) is shown generally in FIGS. 1-2 to include a floating platform (10), a ballast platform (12), a guide cylinder (14), an air/water tank (16), a compressor assembly (18), and a plurality of electrical generators (20a, 20b, 20c, 22a, 22b).

The floating platform (10) comprises a buoyant body (24), a flat horizontal upper surface (26) for supporting and providing stability for components of the system (1) positioned thereon, and a flat horizontal lower surface (28) for connecting to other components of the system (1). The floating platform (10) may be sized and shaped to accommodate components of the system (1). In some embodiments, the floating platform (10) is sufficiently sized and shaped to support surface electrical generators (20a, 20b, 20c) and the compressor assembly (18). In some embodiments, the floating platform (10) may be square-shaped, rectangular-shaped, or other shapes (FIG. 2). The floating platform (10) may be formed of any suitable materials including, but not limited to, steel, plastic (e.g., polyethylene, polystyrene), and the like. The floating platform (10) retains its position on the surface of the water body (2) and resists wind and current forces by being securely anchored vertically to the opposing ballast platform (12).

The ballast platform (12) is configured to serve as a stable underwater foundation which supports and anchors components of the system (1) positioned thereon and thereabove, and can withstand current forces and imposed underwater stresses. The ballast platform (12) may be sized and shaped to accommodate components of the system (1). In some embodiments, the ballast platform (12) is sufficiently sized and shaped to support submerged electrical generators (22a, 22b) and the guide cylinder (14) on its top surface (30). In some embodiments, the ballast platform (12) may be rectangular-shaped, square-shaped, or other shapes.

In some embodiments, the ballast platform (12) may be formed of any suitable materials including, but not limited to, concrete, plastic (e.g., polyethylene, polystyrene), steel, and the like. In some embodiments, the ballast platform (12) may comprise one or more internal chambers (not shown) that may be selectively filled partially or entirely with fluid or solid ballast to submerge the system (1) in the water body (2), or emptied partially or entirely of fluid or solid ballast to raise the system (1) from the water body (2). Solid ballast may include, but is not limited to, sand, stones, concrete, or iron ore. The bottom surface (32) of the ballast platform (12) may be either suspended above the floor (3) of the water body (2) or rest directly on the floor (3) of the water body (2).

In some embodiments, the floating platform (10) is anchored to the ballast platform (12) by the guide cylinder (14) extending therebetween. The guide cylinder (14) comprises a top end (34), a bottom end (36), and a substantially elongate cylindrical body (38) extending between the top end (34) and the bottom end (36).

In some embodiments, the top end (34) of the guide cylinder (14) is centrally mounted to the floating platform (10) by a first coupling (40) positioned on the lower surface (28) of the floating platform (10). The bottom end (36) of the guide cylinder (14) is centrally mounted to the ballast platform (12) by a second coupling (42) positioned on the top surface (30) of the ballast platform (12).

In some embodiments, the guide cylinder (14) has a length which is less than the depth of the water body (2). In some embodiments, the guide cylinder (14) has a length which is about the depth of the water body (2). In some embodiments, the guide cylinder (14) has a length which extends from the surface (4) of the water body (2) to above the floor (3) of the water body (2). In some embodiments, the guide cylinder (14) has a length which extends from the surface (4) of the water body (2) to about the floor (3) of the water body (2).

The guide cylinder (14) may be formed of any suitable materials including, but not limited to, stainless steel, galvanized steel, and the like. The guide cylinder (14) is sized to accommodate the air/water tank (16). In some embodiments, the guide cylinder (14) comprises an outer diameter (44) which is less than the inner diameter (46) of the air/water tank (16) (FIG. 2) so that the air/water tank (16) and guide cylinder (14) are positioned concentrically. The guide cylinder (14) directs the translational vertical movement of the air/water tank (16) upwardly towards the floating platform (10), and downwardly towards the ballast platform (12).

In some embodiments, the air/water tank (16) comprises a conically-shaped top portion (48), a body (50) having cylindrical side walls, and a conically-shaped and downwardly sloping bottom portion (52). The top portion (48), body (50), and bottom portion (52) together define a unitary central bore (54) (FIG. 2) for receiving compressed air and water, and allowing the guide cylinder (14) to extend therethrough.

The top portion (48) of the air/water tank (16) is configured to support one or more submerged compressed air tanks (56) from which it receives compressed air through one or more conduits (58). In some embodiments, a pair of submerged compressed air tanks (56) is provided. Each submerged compressed air tank (56) comprises a vessel for receiving and storing compressed air through an air valve (60).

The bottom portion (52) of the air/water tank (16) comprises at least one water valve (62a, 62b) for regulating the flow of water from the water body (2) into the air/water tank (16), and the flow of water out of the air/water tank (16) into the water body (2). In some embodiments, the bottom portion (52) comprises a pair of water valves (62a, 62b). In some embodiments, the water valves (62a, 62b) are opposed to allow equal flows of water into and out of the air/water tank (16). In some embodiments, the water valves (62a, 62b) are formed of stainless steel, galvanized steel, and the like.

In some embodiments, a compressor assembly (18) comprises a compressor and one or more surface air tanks. As used herein, the term “compressor” refers to a device which converts power (using a motor or engine) into potential energy stored in pressurized gas. In some embodiments, the compressor generates compressed air. In some embodiments, the compressor assembly (18) is mounted on the floating platform (10). In some embodiments, the compressor assembly (18) is centrally mounted on the top surface (28) of the floating platform (10) between the surface electrical generators (20a, 20b, 20c).

The compressed air is stored in one or more surface air tanks mounted on the floating platform (10), and is delivered to the submerged compressed air tanks (56) through one or more conduits (64). An air recharge funnel valve (66) regulates the flow of the compressed air from the surface air tanks into the submerged compressed air tanks (56). In some embodiments, the surface air tanks may temporarily store compressed air for delivery to the submerged compressed air tanks (56) when the compressor is not running or for supplying additional compressed air during periods of high demand. The surface air tanks may thus expand the storage capacity of compressed air in the system (1) to supply additional flow as needed.

The system (1) comprises a plurality of electrical generators (20a, 20b, 20c, 22a, 22b) which generate energy by converting motive power (mechanical energy) into electricity for use in an external circuit. Suitable types of electrical generators include, but are limited to dynamos, alternators, and the like.

In some embodiments, one or more surface electrical generators (20a, 20b, 20c) are positioned on the floating platform (10). In some embodiments, three surface electrical generators (20a, 20b, 20c) are provided (FIG. 2). The surface electrical generators (20a, 20b, 20c) are connected to the top portion (48) of the air/water tank (16) by upper cables (68a, 68b, third cable connected to the surface electrical generator (20c) at the rear is not shown for clarity).

In some embodiments, one or more submerged electrical generators (22a, 22b) are positioned on the ballast platform (12). In some embodiments, three submerged electrical generators (22a, 22b) are provided (third submerged electrical generator in the rear is not shown for clarity). The submerged electrical generators (22a, 22b) are connected to the bottom portion (52) of the air/water tank (16) by lower cables (70a, 70b, third cable connected to the submerged electrical generator at the rear is not shown for clarity).

In some embodiments, the upper and lower cables (68a, 68b, 70a, 70b) comprise aircraft cables. As used herein, the term “aircraft cable” refers to a type of wire rope comprising a plurality of steel wires stranded together to confer flexibility and strength.

In operation, the system (1) is installed with the floating platform (10) on the surface (4) of the water body (2), and the ballast platform (12) suspended above or resting directly and stably on the floor (3) of the water body (2). A controller (not shown) including instructions programmed by a user directs the functions of the system (1). In some embodiments, the system (1) may be fully controlled remotely. Within the compressor assembly (18), the compressor is run to generate sufficient compressed air to completely fill both the surface air tanks and the submerged compressed air tanks (56).

The water valves (62a, 62b) are opened to allow the flow of water (indicated by the upward arrows in FIG. 1) from the water body (2) into the air/water tank (16). As water starts to fill the body (50) of the air/water tank (16) from the bottom portion (52) towards the top portion (48), the air (indicated by the downward arrows in FIG. 1) within the air/water tank (16) compresses on the top portion (48) of the air/water tank (16). When the volume of water reaches a predetermined level (72), the water valves (62a, 62b) are closed. By gravity, the air/water tank (16) begins to dive (i.e., the downstroke). As the air/water tank (16) moves along the guide cylinder (14) downwardly towards the ballast platform (12), the air/water tank (16) pulls the upper cables (68a, 68b) connected to the surface electrical generators (20a, 20b, 20c), thereby generating electrical energy.

When the air/water tank (16) reaches the ballast platform (12), the water valves (62a, 62b) are opened. The submerged compressed air tanks (56) discharge compressed air to push water out of the air/water tank (16) through the water valves (62a, 62b) into the water body (2). This action causes the air/water tank (16) to rise (i.e., the upstroke). As the air/water tank (16) moves along the guide cylinder (14) upwardly towards the floating platform (10), the air/water tank (14) pulls the lower cables (70a, 70b) connected to the submerged electrical generators (22a, 22b), thereby generating electrical energy.

When the air/water tank (16) reaches the floating platform (10), the air valve (60) of the submerged compressed air tanks (56) connects with the air recharge funnel valve (66) to enable the re-filling of the submerged compressed air tanks (56) with compressed air from the surface air tanks of the compressor assembly (18). In some embodiments, a portion of the energy generated during the cycle may be used to actuate the filling of the submerged compressed air tanks (56). In this manner, the system (1) thus efficiently generates electrical energy using gravity on the downstroke and using a pressure differential (i.e., between underwater pressure and atmospheric air pressure) on the upstroke.

It should be apparent, however, to those skilled in the art that many more modifications besides those already described are possible without departing from the inventive concepts herein.

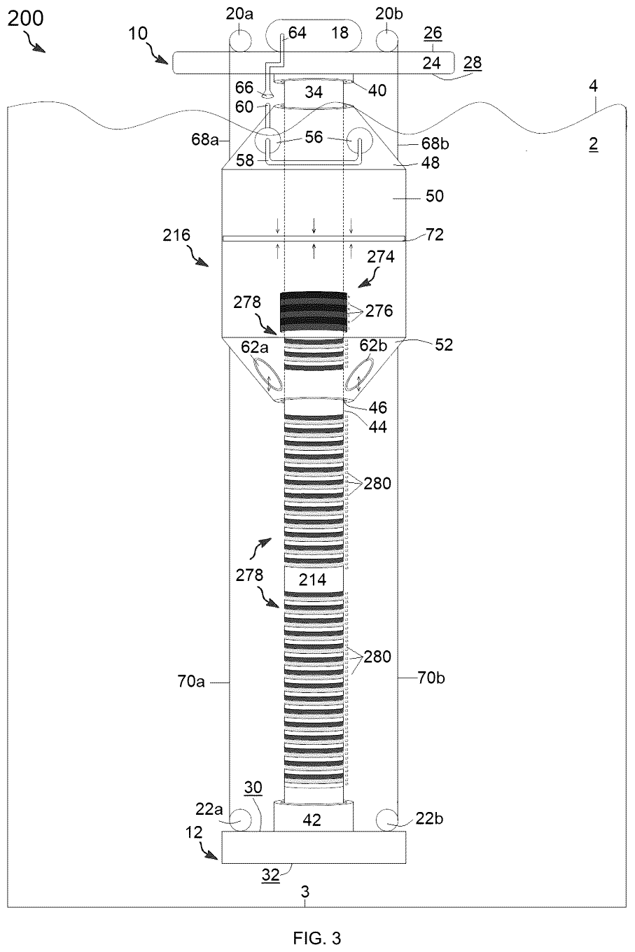

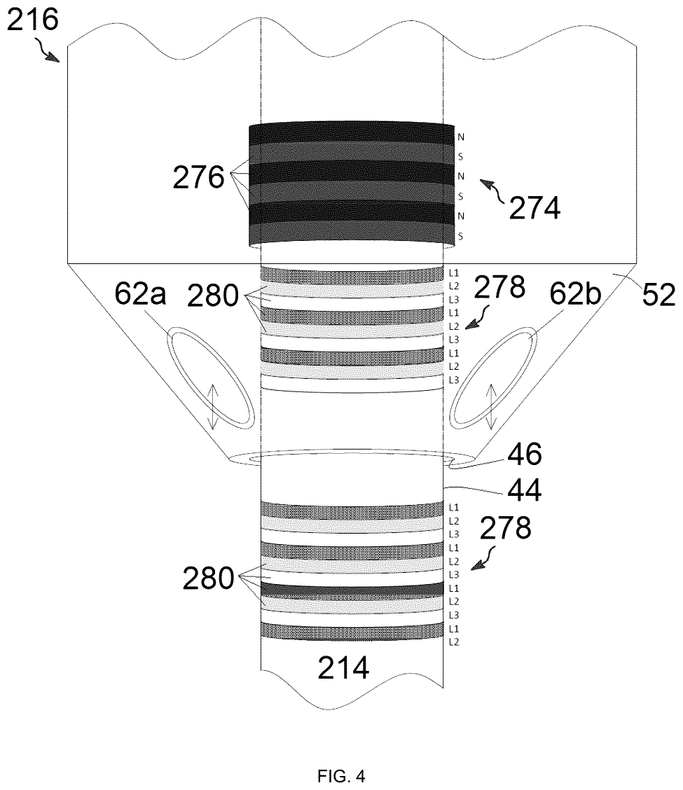

In a second embodiment, the system (200) is shown generally in FIGS. 3-4 to include the same features as the first embodiment of the system (1) shown in FIGS. 1-2, with the exception that the second embodiment of the apparatus (200) comprises different configurations for the air/water tank (216) and the guide cylinder (214).

In some embodiments, the air/water tank (216) comprises a magnet assembly (274). The magnet assembly (274) comprises a plurality of magnets (276). As used here, the term “magnet” refers to a permanent magnet or an object made from a material that is magnetized and creates its own persistent magnetic field. It can attract other ferromagnetic materials such as, for example, iron, or an opposite magnetic field created by permanent magnets or electromagnets. In some embodiments, the magnet (276) is a permanent magnet. The magnet (276) has two surfaces, each having opposing polarity (i.e., referred to as “S” or “south-seeking” or “positive (+)” on one surface, “N” or “north-seeking” or “negative (−)” on the other surface). In some embodiments, adjacent magnets (276) are oriented to have opposite polarities (for example, “N S N S N S” as shown in FIG. 4). In some embodiments, the magnets (276) are oriented to have opposite polarities in groups, not necessarily alternating per magnet (for example, two per group as in “NN SSNN SSNNSS”; three per group as in “NNNSSSNNNSSSNNNSSS”). It will be appreciated that other predetermined patterns of magnets (276) may also be utilized. The number of magnets (276) may vary. In one embodiment, the air/water tank (216) has an even number of magnets (276). In some embodiments, the magnets (276) are positioned in a predetermined pattern within at least a portion of the body (50) of the air/water tank (216). In some embodiments, the magnets (276) are positioned circumferentially around the inner diameter (46) of the body (50).

In some embodiments, the guide cylinder (214) comprises one or more magnetic coil assemblies (278). As used herein, the term “magnetic coil” refers to a wound spiral or coil (280) of one or more turns of magnet wire or winding wire which is an insulated conductor for producing a magnetic field. The more turns of wire on the coil (280), the stronger the magnetic field will be. The magnetic fields generated by the separate turns of wire will all pass through the center of the coil (280) producing a strong magnetic field. As shown in FIG. 4, “L1”, “L2”, and “L3” designate different magnetic coil units within the magnetic coil assembly (278). It will be appreciated that other predetermined patterns of magnetic coil assemblies (278) may also be utilized. The number of magnetic coil assemblies (278) may vary. In one embodiment, the guide cylinder (214) has three magnetic coil assemblies (278). In some embodiments, the magnetic coil assemblies (278) are positioned spaced apart in a predetermined pattern along the length of the guide cylinder (216). In some embodiments, the magnetic coil assemblies (278) are positioned circumferentially around the outer diameter (44) of the guide cylinder (216).

In operation, the system (200) is installed with the floating platform (10) on the surface (4) of the water body (2), and the ballast platform (12) suspended above or resting on the floor (3) of the water body (2). A controller (not shown) including instructions programmed by a user directs the functions of the system (200). In some embodiments, the system (200) may be fully controlled remotely. Within the compressor assembly (18), the compressor is run to generate sufficient compressed air to completely fill both the surface air tanks and the submerged compressed air tanks (56).

The water valves (62a, 62b) are opened to allow the flow of water (indicated by the upward arrows in FIG. 3) from the water body (2) into the air/water tank (216). As water starts to fill the air/water tank (216) from the bottom portion (52) towards the top portion (48), the air (indicated by the downward arrows in FIG. 3) within the air/water tank (216) compresses on the top portion (48) of the air/water tank (216). When the volume of water reaches a predetermined level (72), the water valves (62a, 62b) are closed. By gravity, the air/water tank (216) begins to dive (i.e., the downstroke).

As the air/water tank (216) moves along the guide cylinder (214) downwardly towards the ballast platform (12), the air/water tank (216) pulls the upper cables (68a, 68b) connected to the surface electrical generators (20a, 20b, 20c), thereby generating electrical energy. In addition, as the air/water tank (216) moves along the guide cylinder (214) downwardly towards the ballast platform (12), the permanent magnets (276) of the air/water tank (216) pass over the magnetic coil assemblies (278) of the guide cylinder (214), thereby also generating electrical energy.

When the air/water tank (216) reaches the ballast platform (12), the water valves (62a, 62b) are opened. The submerged compressed air tanks (56) discharge compressed air to push water out of the air/water tank (216) through the water valves (62a, 62b) into the water body (2). This action causes the air/water tank (216) to rise (i.e., the upstroke). As the air/water tank (216) moves along the guide cylinder (214) upwardly towards the floating platform (10), the air/water tank (216) pulls the lower cables (70a, 70b) connected to the submerged electrical generators (22a, 22b), thereby generating electrical energy. In addition, as the air/water tank (216) moves along the guide cylinder (214) upwardly towards the floating platform (10), the permanent magnets (276) of the air/water tank (216) pass over the magnetic coil assemblies (278) of the guide cylinder (214), thereby also generating electrical energy.

When the air/water tank (216) reaches the floating platform (10), the air valve (60) of the submerged compressed air tanks (56) connects with the air recharge funnel valve (66) to enable the re-filling of the submerged compressed air tanks (56) with compressed air from the surface air tanks of the compressor assembly (18). In some embodiments, a portion of the energy generated during the cycle may be used to actuate the filling of the submerged compressed air tanks (56).

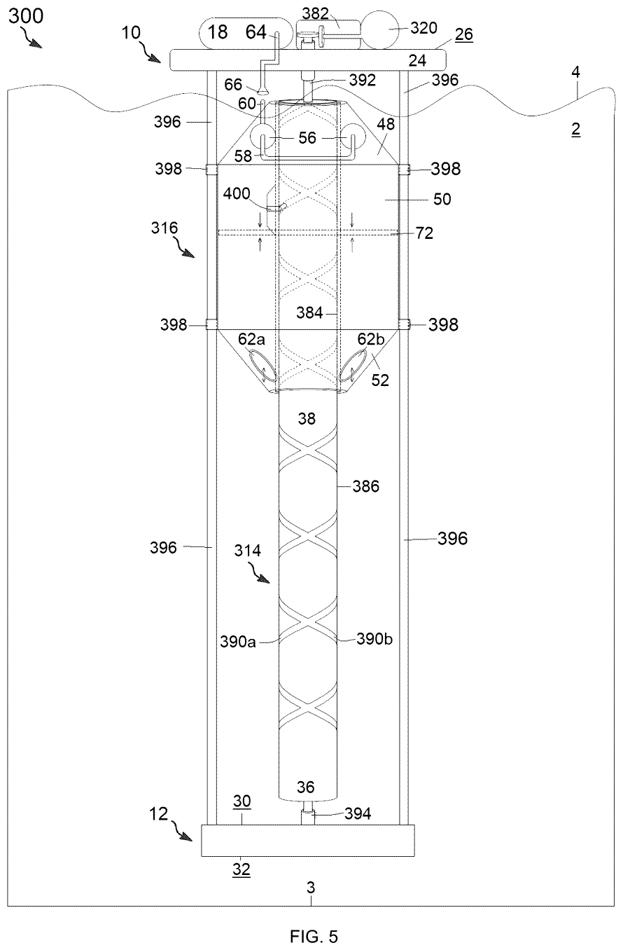

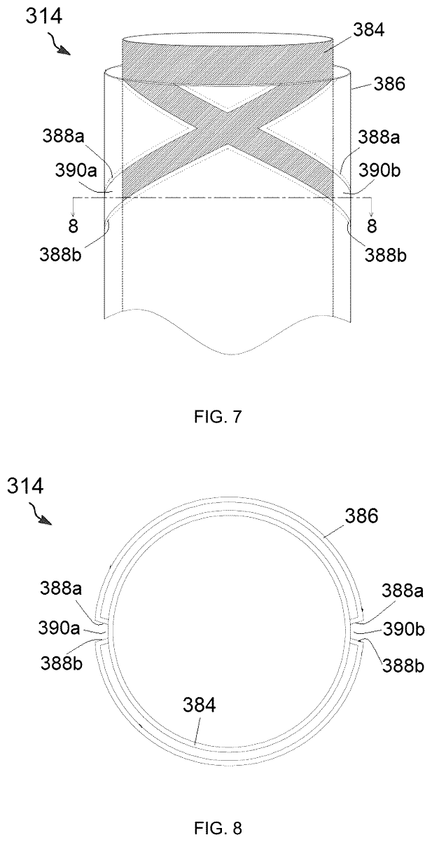

In a third embodiment, the system (300) is shown generally in FIGS. 5-8 to include certain features of the first and second embodiments shown in FIGS. 1-4, with the exception that the third embodiment of the system (300) comprises different configurations for the air/water tank (316) and cylinder (314), and includes a gear box (382) and surface electrical generator (320).

In some embodiments, a gear box (382) and a surface electrical generator (320) are operably connected and positioned on the floating platform (10). As used herein, the term “gear box” refers to a casing within which a train of gears is sealed. The gears transfer energy from a rotatable power source to the surface electrical generator (320) which generates energy by converting the energy received from the gears into electricity for use in an external circuit.

In some embodiments, the rotatable power source comprises a rotatable cylinder (314) in the form of a cylindrical cam or barrel cam. The rotatable cylinder (314) comprises a top end (34), a bottom end (36), and a substantially elongate cylindrical body (38) extending between the top end (34) and the bottom end (36). In some embodiments, the elongate cylindrical body (38) has a length which is substantially the same or about the depth of the water body (2). In some embodiments, the elongate cylindrical body (38) has a length which is substantially less than the depth of the water body (2). In some embodiments, the rotatable cylinder (314) extends from the surface (4) of the water body (2) to above the floor (3) of the water body (2). In some embodiments, the rotatable cylinder (314) extends from the surface (4) of the water body (2) to about the floor (3) of the water body (2).

In some embodiments, the rotatable cylinder (314) comprises an inner pipe (384) and an outer pipe (386). As shown in FIG. 8, opposed portions of the outer pipe wall (388a, 388b) bend inwardly and are securely attached to the inner pipe (384) by welding or other suitable technique, to define opposed guide channels (390a, 390b). In some embodiments, the guide channels (390a, 390b) extend in a predetermined pattern along the length of the rotatable cylinder (314). In some embodiments as shown in FIGS. 5-7, the guide channels (390a, 390b) form spiralling “X”-shapes. In some embodiments, the rotatable cylinder (314) may comprise a solid metal axle into which grooves have been machined or cut during manufacture.

The top end (34) of the rotatable cylinder (314) is centrally mounted to the floating platform (10) by first support means (392) positioned on the lower surface (28) of the floating platform (10) (FIG. 5). The bottom end (36) of the rotatable cylinder (314) is centrally mounted to the ballast platform (12) by support means (394) positioned on the top surface (30) of the ballast platform (12). Suitable support means (392, 394) include, but are not limited to, supports, bearings, and the like.

The rotatable cylinder (314) may be formed of any suitable materials including, but not limited to, stainless steel, galvanized steel, and the like. The rotatable cylinder (314) is sized to accommodate the air/water tank (316). In some embodiments, the rotatable cylinder (314) comprises an outer diameter (44) which is less than the inner diameter (46) of the air/water tank (316) so that the air/water tank (316) and rotatable cylinder (314) are positioned concentrically.

In some embodiments, the air/water tank (316) comprises a conically-shaped top portion (48), a body (50) having cylindrical side walls, and a conically-shaped and downwardly sloping bottom portion (52). The top portion (48), body (50), and bottom portion (52) together define a unitary central bore (54) for receiving compressed air and water, and allowing the rotatable cylinder (314) to extend therethrough.

The air/water tank (316) is mounted onto elongated guide poles (396) which extend between the floating platform (10) and the ballast platform (12). In some embodiments, a pair of guide poles (396) extend between the floating platform (10) and the ballast platform (12). In some embodiments, the air/water tank (316) is mounted onto the guide poles (396) by a plurality of guide supports (398). In some embodiments, there are two pairs of guide supports (398). In some embodiments, one pair of guide supports (398) is positioned on the body (50) below the top portion (48), and the other pair of guide supports (398) is positioned on the body (50) above the bottom portion (52). In some embodiments, the air/water tank (316) is mounted to be movable upwardly towards the floating platform (10), and downwardly towards the ballast platform (12).

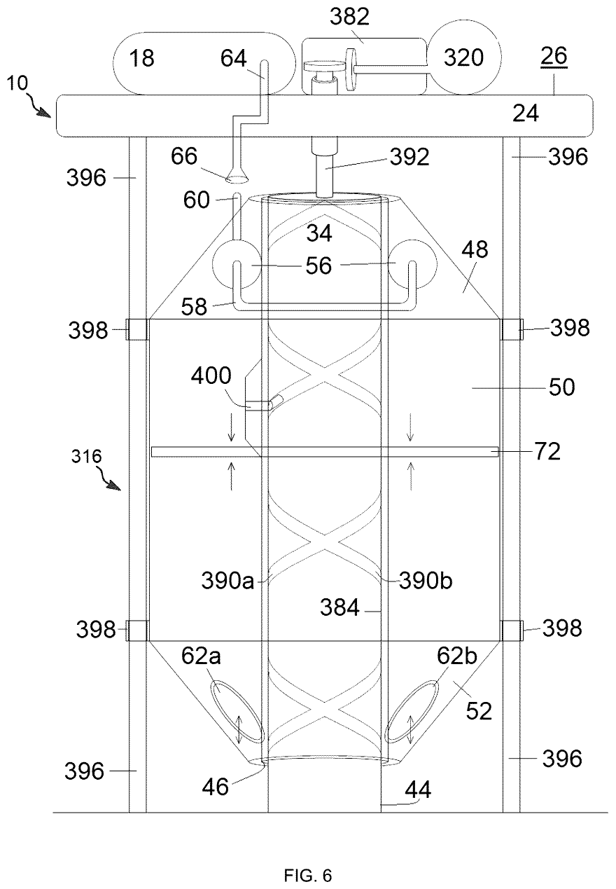

In some embodiments, the air/water tank (316) comprises a follower (400) configured on its inner diameter (46) to ride within the guide channels (390a, 390b) of the rotatable cylinder (314) (FIG. 6).

In operation, the system (300) is installed with the floating platform (10) on the surface (4) of the water body (2), and the ballast platform (12) suspended above or resting on the floor (3) of the water body (2). A controller (not shown) including instructions programmed by a user directs the functions of the system (300). In some embodiments, the system (300) may be fully controlled remotely. Within the compressor assembly (18), the compressor is run to generate sufficient compressed air to completely fill both the surface air tanks and the submerged compressed air tanks (56).

The water valves (62a, 62b) are opened to allow the flow of water (indicated by the upward arrows in FIG. 5-6) from the water body (2) into the air/water tank (316). As water starts to fill the air/water tank (316) from the bottom portion (52) towards the top portion (48), the air (indicated by the downward arrows in FIGS. 5-6) within the air/water tank (316) compresses on the top portion (48) of the air/water tank (316). When the volume of water reaches a predetermined level (72), the water valves (62a, 62b) are closed. By gravity, the air/water tank (316) begins to dive (i.e., the downstroke).

As the air/water tank (316) moves downwardly along the guide poles (396) towards the ballast platform (12), the follower (400) moves downwardly within the guide channels (390a, 390b), causing the rotatable cylinder (314) to rotate about its vertical axis. In this manner, the rotatable cylinder (314) converts rotational motion to linear motion parallel to the rotational axis of the rotatable cylinder (314). The linear motion in turn actuates the gears within the gearbox (382). The gears transfer the energy from the rotatable cylinder (314) to the surface electrical generator (320) which generates energy by converting the energy received from the gears into electricity for use in an external circuit.

When the air/water tank (316) reaches the ballast platform (12), the water valves (62a, 62b) are opened. The submerged compressed air tanks (56) discharge compressed air to push water out of the air/water tank (316) through the water valves (62a, 62b) into the water body (2). This action causes the air/water tank (316) to rise (i.e., the upstroke). As the air/water tank (316) moves upwardly along the guide poles (396) towards the floating platform (10), the follower (400) moves upwardly within the guide channel (390a), causing the rotatable cylinder (314) to rotate about its vertical axis. Rotation of the rotatable cylinder (314) in turn actuates the gears within the gearbox (382). The gears transfer the energy from the rotatable cylinder (314) to the surface electrical generator (320) which generates energy by converting the energy received from the gears into electricity for use in an external circuit.

When the air/water tank (316) reaches the floating platform (10), the air valve (60) of the submerged compressed air tanks (56) connects with the air recharge funnel valve (66) to enable the re-filling of the submerged compressed air tanks (56) with compressed air from the surface air tanks of the compressor assembly (18). In some embodiments, a portion of the energy generated during the cycle may be used to actuate the filling of the submerged compressed air tanks (56).

Components of the systems (1, 200, 300) can be constructed from any materials or combinations of materials having suitable properties such as, for example, appropriateness for use in a water body, mechanical strength, ability to withstand cold, adverse, and stress conditions, rust and corrosion resistance, and ease of machining. The dimensions are not essential to the invention and are dictated by the various sizes, dimensions, and shapes of the components. The dimensions may be increased or decreased as may be required to satisfy any particular design objectives. The energy output can be modified as desired by modifying the configurations of the components including, but not limited to, sizes of the tanks and electrical generators, length of the guide and rotatable cylinders, run time for actuating the water valves, etc.

It should be apparent, however, to those skilled in the art that many more modifications besides those already described are possible without departing from the inventive concepts herein. The inventive subject matter is not to be restricted except in the scope of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. As used herein and in the appended claims, the singular forms “a,” “an,” and “the” include plural referents unless the context clearly dictates otherwise. In addition, the components and steps described in the above embodiments and figures are merely illustrative and do not imply that any particular component or step is a requirement of a claimed embodiment.

1. An underwater energy generation and storage system for use in a water body comprising:
a floating platform positioned on a surface of the water body for supporting a compressor assembly and one or more surface electrical generators;
a ballast platform positioned above or on a floor of the water body for anchoring the floating platform;
a cylinder coupled between the floating platform and the ballast platform; and
an air/water tank positioned concentrically with the cylinder and moveable along the cylinder to generate electrical energy in an upstroke towards the floating platform and a downstroke towards the ballast platform.

2. The system of claim 1, wherein the air/water tank comprises a conically-shaped top portion, a body having cylindrical side walls, and a conically-shaped and downwardly sloping bottom portion, wherein the top portion, body, and bottom portion define a unitary central bore for receiving compressed air and water, and for allowing the cylinder to extend therethrough.

3. The system of claim 2, wherein the top portion is configured to support one or more submerged compressed air tanks for receiving compressed air from the compressor assembly, the compressor assembly comprising a compressor for generating the compressed air and one or more surface air tanks for storing the compressed air.

4. The system of claim 3, further comprising an air recharge funnel valve for regulating flow of the compressed air from the one or more surface air tanks into the one or more submerged compressed air tanks.

5. The system of claim 2, wherein the bottom portion comprises at least one valve for regulating flow of water from the water body into the air/water tank during the downstroke, and out of the air/water tank during the upstroke.

6. The system of claim 2, wherein the one or more surface electrical generators are connected to the top portion of the air/water tank by upper cables.

7. The system of claim 6, further comprising one or more submerged electrical generators positioned on the ballast platform and connected to the bottom portion of the air/water tank by lower cables.

8. The system of claim 2, wherein the air/water tank comprises a magnet assembly, the magnet assembly comprising a plurality of magnets positioned circumferentially in a predetermined pattern within the body of the air/water tank.

9. The system of claim 8, wherein the cylinder comprises one or more magnetic coil assemblies positioned spaced apart in a predetermined pattern along the cylinder.

10. The system of claim 1, further comprising a gear box comprising gears operably connected to the surface electrical generator.

11. The system of claim 10, wherein the cylinder is configured in the form of a cylindrical cam comprising a plurality of guide channels.

12. The system of claim 11, wherein the air/water tank is mounted onto guide poles extending between the floating platform and the ballast platform by a plurality of guide supports, the air/water tank comprising a follower capable of riding within the guide channels for rotating the cylinder.

13. A method of generating and storing energy using the system of claim 1 comprising:
installing the system with the floating platform on a surface of a water body, and the ballast platform suspended above or resting on a floor of the water body;
generating, using the compressor assembly, sufficient compressed air to fill surface air tanks and submerged compressed air tanks;
opening valves to allow the flow of water from the water body into the air/water tank;
closing the valves when the water reaches a predetermined level;
allowing the air/water tank to move under gravity towards the ballast platform in the downstroke to generate electrical energy;
opening the valves to allow the flow of water out of the air/water tank under pressure from the compressed air;
allowing the air/water tank to rise towards the floating platform in the upstroke to generate electrical energy; and
re-filling the submerged compressed air tanks with compressed air from the surface air tanks for a next cycle.

14. The method of claim 13, wherein the air/water tank pulls upper cables connected to the surface electrical generators in the downstroke to generate electrical energy, and wherein the air/water tank pulls lower cables connected to submerged electrical generators in the upstroke to generate electrical energy.

15. The method of claim 18, wherein the magnets of the air/water tank pass over the magnetic coil assemblies of the cylinder to generate electrical energy.

16. The method of claim 20, wherein the follower moves downwardly within the guide channels for rotating the cylinder and actuating gears for transferring energy to the surface electrical generator to generate electrical energy.

17. The method of claim 14, wherein the air/water tank comprises a magnet assembly, the magnet assembly comprising a plurality of magnets positioned circumferentially in a predetermined pattern within the body of the air/water tank.

18. The method of claim 17, wherein the cylinder comprises one or more magnetic coil assemblies positioned spaced apart in a predetermined pattern along the cylinder.

19. The method of claim 13, wherein a gear box comprising gears is operably connected to the surface electrical generator, and the cylinder is configured in the form of a cylindrical cam comprising a plurality of guide channels.

20. The method of claim 19, wherein the air/water tank is mounted onto guide poles extending between the floating platform and the ballast platform by a plurality of guide supports, the air/water tank comprising a follower capable of riding within the guide channels.
